(19) United States
(12) Patent Application Publication
(10) Pub. No.: US 2014/0295826 A1
(43) Pub. Date: Oct. 2, 2014

(54) METHOD AND APPARATUS FOR CONTROLLING TRAFFIC NEXT GENERATION MOBILE COMMUNICATION SYSTEM

(71) Applicant: Electronics and Telecommunications Research Institute, Daejeon-si (KR)

(72) Inventors: Sung Gu CHOI, Daejeon (KR); Young Jick BAHG, Daejeon (KR); Byung Han RYU, Daejeon (KR); Nam Hoon PARK, Daejeon (KR)

(73) Assignee: Electronics and Telecommunications Research Institute, Daejeon-si (KR)

(21) Appl. No.: 14/100,264

(22) Filed: Dec. 9, 2013

(30) Foreign Application Priority Data
Mar. 27, 2013 (KR) 10-2013-0032976

(51) Int. Cl. H04W 36/00; H04W 28/02; H04W 76/02

(52) U.S. Cl. CPC H04W 36/0094; H04W 76/023; H04W 28/0215
USPC 455/426.1; 455/552.1

(57) ABSTRACT

The present invention relates to a method and apparatus for controlling traffic which can be applied to the next generation mobile communication system. The method includes determining whether or not a load state of a cell is greater than a threshold, determining whether or not UE capable of D2D communication is present in UEs connected to the cell if, as a result of the determination, it is determined that the load state is greater than the threshold, performing a D2D communication configuration on the UE capable of D2D communication, determining whether or not UE capable of handover is present in remaining UEs not capable of the D2D communication, and performing a handover communication configuration on the UE capable of handover. According to the present invention, a signaling overload due to the simultaneous handover of a plurality of UEs or congestion of traffic in a target cell can be prevented.

This application claims priority to and the benefit of Korean patent application number 10-2013-0032976 filed on Mar. 27, 2013, the entire disclosure of which is incorporated by reference herein.

### BACKGROUND OF THE INVENTION

1. Field of the Invention

The present invention relates to wireless communication and, more particularly, to a method and apparatus for controlling traffic, which can be applied to the next generation mobile communication system.

2. Discussion of the Related Art

Recently, as smart phones and tablet Personal Computers (PCs) are spread out and high-capacity multimedia communication is activated, mobile traffic is suddenly increased. Communication service providers have been faced with a severe network load problem because most of the mobile traffic is transmitted through an evolved NodeB (eNB). In order to handle the increasing traffic, communication service providers are increasing network equipment and have used the next generation mobile communication standards capable of efficiently processing a large amount of traffic, such as mobile WiMAX and Long Term Evolution (LTE). However, other solutions are necessary to handle the amount of traffic that will be further suddenly increased in the future.

A method of solving a network overload in a mobile communication system includes an on-off-based overload control scheme for a network. The on-off-based overload control scheme is problematic in that service is no longer provided to User Equipment (UE) connected to a network. Furthermore, there is a method of performing handover in order to maintain the continuity of service regarding traffic that is being served before a network enters off-state mode. In this case, however, the overall performance of a system can be deteriorated because signaling is simultaneously transmitted and received for handover procedures performed by a plurality of UEs and a large amount of traffic is instantly generated in a target cell that accommodates the handover.

Meanwhile, distribution type communication in which traffic is directly transferred between adjacent nodes without using infrastructure, such as an eNB, is called Device-To-Device (D2D) communication. In D2D communication environment, each node, such as a handheld terminal, autonomously searches for another UE that is physically adjacent to the node, sets up a communication session, and then sends traffic. D2D communication has been in the spotlight as an element technique for the next generation mobile communication technology after 4G because traffic concentrated on an eNB is distributed in order to solve a traffic overload problem as described above. D2D communication includes all of existing Human-To-Human (HTH) communication in which communication is performed between persons, Machine-To-Human (MTH) communication in which communication is performed between a device and a person, and Machine-To-Machine (MTM) communication or Machine Type Communication (MTC) in which communication is directly performed between devices. UE supporting D2D communication can be called D2D UE, and D2D UEs can perform D2D communication when an event or condition that satisfies given conditions in a specific environment is generated.

### SUMMARY OF THE INVENTION

An object of the present invention is to provide a method and apparatus for controlling traffic in a mobile communication system.

Another object of the present invention is to provide a method and apparatus for performing traffic control in a network using D2D communication.

Yet another object of the present invention is to provide an efficient method and apparatus for performing traffic control when an overload occurs in a network.

Further yet another object of the present invention is to improve the performance of a system by minimizing usage efficiency of resources.

In accordance with an aspect of the present invention, there is provided a method of controlling traffic in a network in a mobile communication system. The method includes determining whether or not a load state of a cell is greater than a threshold, determining whether or not UE capable of D2D communication is present in UEs connected to the cell if, as a result of the determination, it is determined that the load state is greater than the threshold, performing a D2D communication configuration on the UE capable of D2D communication, determining whether or not UE capable of handover is present in the remaining UEs not capable of the D2D communication, and performing a handover communication configuration on the UE capable of handover.

In accordance with another aspect of the present invention, there is provided a method of controlling traffic in a network in a mobile communication system. The method includes determining whether or not a load state of a cell is greater than a threshold, requesting at least one of information about UE capable of D2D communication, information about UE capable of handover, and information about the state of a neighbor cell from a specific DB if, as a result of the determination, it is determined that the load state is greater than the threshold, receiving at least one of the information about UE capable of D2D communication, the information about UE capable of handover, and the information about the state of a neighbor cell from the DB, determining whether or not UE capable of D2D communication is present in UEs connected to the cell based on the received information about UE capable of D2D communication, performing a D2D communication configuration on the UE capable of D2D communication, determining whether or not UE capable of handover is present in the remaining UEs not capable of D2D communication based on at least one of the received information about UE capable of handover and the received information about the state of a neighbor cell, and performing a handover communication configuration on the UE capable of handover.

In accordance with yet another aspect of the present invention, there is provided an overload control apparatus for performing traffic control in a mobile communication system. The system includes a load determination unit for determining whether or not a load state of a cell is greater than a threshold, a D2D determination unit for determining whether or not UE capable of D2D communication is present in UEs connected to the cell if, as a result of the determination, it is determined that the load state is greater than the threshold, a control unit for performing a D2D communication configuration on the UE capable of D2D communication, and a handover determination unit for determining whether or not UE capable of handover is present in the remaining UEs not capable of the D2D communication, wherein the control unit performs a handover communication configuration on the UE capable of handover.

### BRIEF DESCRIPTION OF THE DRAWINGS

FIG. 1 shows an example of a configuration of the next generation mobile communication system in an overlap network environment;

FIG. 2 shows an embodiment in which BS cells are operated in an overload control state according to the present invention;

FIG. 3 is a flowchart illustrating an example of a method of controlling traffic (overload), which is performed by an overload control apparatus according to the present invention;

FIG. 4 is a flowchart illustrating another example of a method of controlling traffic (overload), which is performed by the overload control apparatus according to the present invention; and

FIG. 5 is a block diagram of the overload control apparatus for performing traffic (overload) in a network according to the present invention.

### DETAILED DESCRIPTION OF THE EMBODIMENTS

Hereinafter, in this specification, some exemplary embodiments of the present invention will be described in detail with reference to the accompanying drawings. It is to be noted that in assigning reference numerals to elements in the drawings, the same reference numerals denote the same elements throughout the drawings even in cases where the elements are shown in different drawings. Furthermore, in describing the embodiments of the present invention, a detailed description of the known functions and constitutions will be omitted if it is deemed to make the gist of the present invention unnecessarily vague.

Furthermore, in describing the elements of this specification, terms, such as the first, the second, A, B, (a), and (b), may be used. However, although the terms are used only to distinguish one element from the other element, the essence, order, or sequence of the elements is not limited by the terms. When it is said that one element is ‘connected’, ‘combined’, or ‘coupled’ with the other element, the one element may be directly connected or coupled with the other element, but it should also be understood that a third element may be ‘connected’, ‘combined’, or ‘coupled’ between the two elements.

Furthermore, in this specification, a wireless communication network is described as a target, and tasks performed in the wireless communication network can be performed in a process in which a system (e.g., a base station) managing the wireless communication network controls the wireless communication network and sends data or can be performed by a terminal that accesses the wireless communication network.

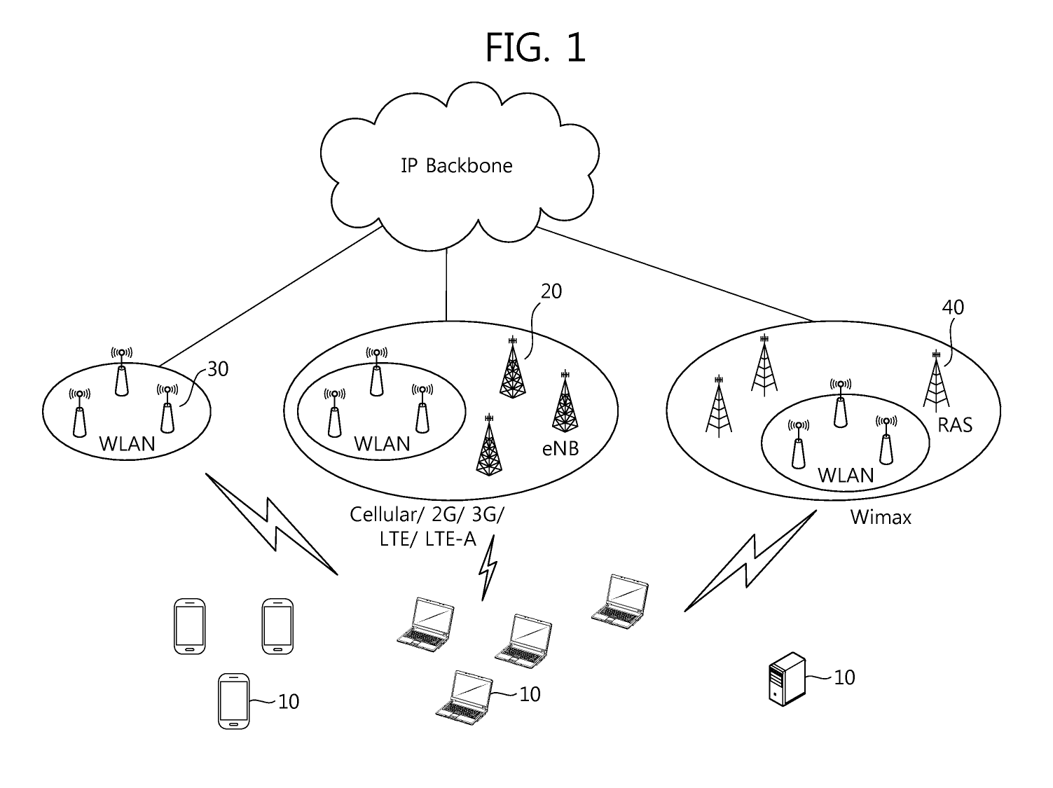

FIG. 1 shows an example of a configuration of the next generation mobile communication system in an overlap network environment. The next generation mobile communication system is aiming for a high data rate, low latency, and packet-optimized radio access technology and is capable of providing ultra-high speed broadband mobile multimedia packet service to users. The next generation mobile communication system may denote a communication system capable of a high transfer of data and service based on an Internet Protocol (IP).

Referring to FIG. 1, the next generation mobile communication systems are widely deployed in order to provide various communication services, such as voice and packet data. The next generation mobile communication system can include User Equipments (UEs) 10, evolved NodeBs (eNBs) 20, Wireless LAN Access Points (WLAN APs) 30, and Radio Access Stations (RASs) 40. Here, the WLAN AP (or WLAN) is an apparatus that supports Institute of Electrical and Electronics Engineers (IEEE) 802.11 technology, that is, a wireless standard, and an IEEE 802.11 system can be mixed with a Wi-Fi system. Furthermore, the RAS is an apparatus that supports IEEE 802.16 technology, and an IEEE 802.16 system can be mixed with a Wimax or Wibro system.

The UE 10 can be fixed or mobile and can also be called another term, such as a Mobile Station (MT), a User Terminal (UT), a Subscriber Station (SS), a Mobile Terminal (MT), or a wireless device. The eNB 20 refers to a fixed station communicating with the UE 10, and the eNB 20 can also be called another term, such as a Base Station (BS), a Base Transceiver System (BTS), an access point, a femto BS, or a relay. In the next generation mobile communication system, the function of a radio access network (e.g., EUTRAN) is physically implemented using an eNB, and an Evolved-Packet Core (EPC) includes a Mobility Management Entity (MME) that manages a control plane, such as a Mobility Management (MM) function and a Session Management (SM) function, and a User Plane Entity (UPE) that manages a user plane, such as data transfer management.

The UE 10 can be placed in coverage in which a plurality of networks, such as a cellular network, a WLAN, WiMAX, a broadcasting network, and a satellite system, is overlapped with each other. The UE 10 is equipped with a plurality of radio transceivers in order to access a variety of networks and services anwhere, at any time. For example, a smart phone is equipped with Long Term Evolution (LTE), Wi-Fi, WiMAX, and Bluetooth (BT) transceivers and a GPS receiver. Since the next generation mobile communication system is operated in an overlapped cell environment as described above, there is a need for a method of efficiently managing a network having a very large load, that is, an overload network, through the exchange of pieces of information between the networks of different systems or the systems in terms of load control.

In general, when an overload is generated in a network, an on-off based overload control scheme for the network and a scheme for performing handover in order to maintain the continuity of service for traffic being served is in progress before the network enters an off state have been used as network overload control schemes. If the network enters an off state, there are problems in that a coverage hole, that is, a phenomenon in which UE cannot be connected to any cell because the reception sensitivity of electric waves is lowered in a specific area, is generated and thus the continuity of service cannot be guaranteed. Furthermore, there can be a problem in that the overall performance of a system is deteriorated because signaling is increased due to the simultaneous execution of handover by a plurality of UEs and a large amount of traffic is instantly generated in a target cell that accommodates the handover.

In order to supplement the problems, there is a need for an algorithm for a new control scheme capable of maximizing efficiency in overload control. The present invention proposes a load control scheme capable of maximizing the resource usage efficiency of a system and guaranteeing the continuity of service.

In the present invention, in order to solve the largest problem in that service cannot be provided when an overload is generated in a network, D2D communication technology, that is, distribution type communication technology in which traffic is directly transferred between adjacent nodes without using infrastructure, such as an eNB, is used. To this end, it is necessary to check information about UE capable of D2D communication in a network in which an overload has occurred. For example, in a network, that is, the subject of overload control, UE capable of D2D communication, a location of the UE, locations of adjacent cells, and access information can be checked. In this case, in a network, that is, the subject of overload control, control can be performed so that UE capable of D2D communication, a location of the UE, locations of adjacent cells, and access information are checked by searching a database (DB) periodically or aperiodically and D2D communication is performed on traffic service capable of D2D communication. In this case, a service interruption problem for UE connected to a network in which an overload has occurred can be improved, and the continuity of existing service can be guaranteed without imposing a load on the network.

Meanwhile, regarding UE not capable of D2D communication or traffic to which D2D communication cannot be applied, a network or an eNB can determine whether handover can be performed or not and perform handover according to a possible handover type. In this case, processing on real-time traffic that has a great influence on Quality of Service (QoS) can be preferentially performed. Furthermore, whether or not a handover procedure having the smallest signaling that is necessary to perform handover can be determined, and corresponding processing can be performed. For example, a network can perform control so that inter-cell handover and inter-system handover are sequentially performed by giving priority to the inter-cell handover and the inter-system handover. In this case, the continuity of service can be guaranteed by reducing a load of the signaling and traffic of an overload network.

In accordance with the present invention, when an overload is generated in a network, D2D communication can be performed between UEs in a cell edge area or a service area in which UEs can directly perform communication in a corresponding cell. Accordingly, the continuity of traffic being served is provided can be guaranteed without a load on the network.

Furthermore, in accordance with the present invention, when an overload is generated in a network, a possible coverage hole problem can be avoided by controlling traffic based on the on/off of the network. A cell breathing scheme for increasing or decreasing the radius of a cell or a Coordinated Multi-Point (CoMP) scheme with neighboring cells is suggested as a method of avoiding a coverage hole problem. In the schemes, however, interference between cells can be increased and signaling and traffic between cells for CoMP can be instantly increased, with the result that the continuity of service or QoS may not be guaranteed.

Furthermore, as compared with a method of immediately performing handover when an overload is generated in a network, if limited D2D communication is preferentially applied and handover is performed on the remaining traffic being served as in the present invention, usage efficiency of radio resources can be maximized and an increase of signaling and congestion of traffic occurring when performing handover can be prevented. As a result, the continuity of service can be guaranteed, and the performance of a system can be improved.

In present invention, in order to solve the problems, when a traffic load is a threshold or higher in a network, whether or not traffic being served is capable of D2D direct communication is preferentially determined. If, as a result of the determination, the traffic being served is capable of D2D direct communication, the service continues to be provided to UE through a D2D direct communication procedure in order to prevent a service interruption attributable to the switch-off of a cell.

Furthermore, in order to guarantee service continuity, whether or not handover can be performed is determined. If, as a result of the determination, it is determined that handover can be performed, a handover procedure is performed. In this case, congestion of signaling and traffic that may occur when all the UEs connected to a corresponding cell perform handover at the same time can be distributed through D2D communication. In particular, if a cell (or network) overload is controlled through D2D communication, overload control can be optimally performed because continuity can be provided to existing service through direction communication between UEs without using network resources. Furthermore, in this case, there is an advantage in that the switch-on time of an overload network is maintained relatively longer because a traffic threshold, that is, an overload threshold for overload control, can be set to be relatively high. Accordingly, overload control efficiency of a mobile communication system can be increased.

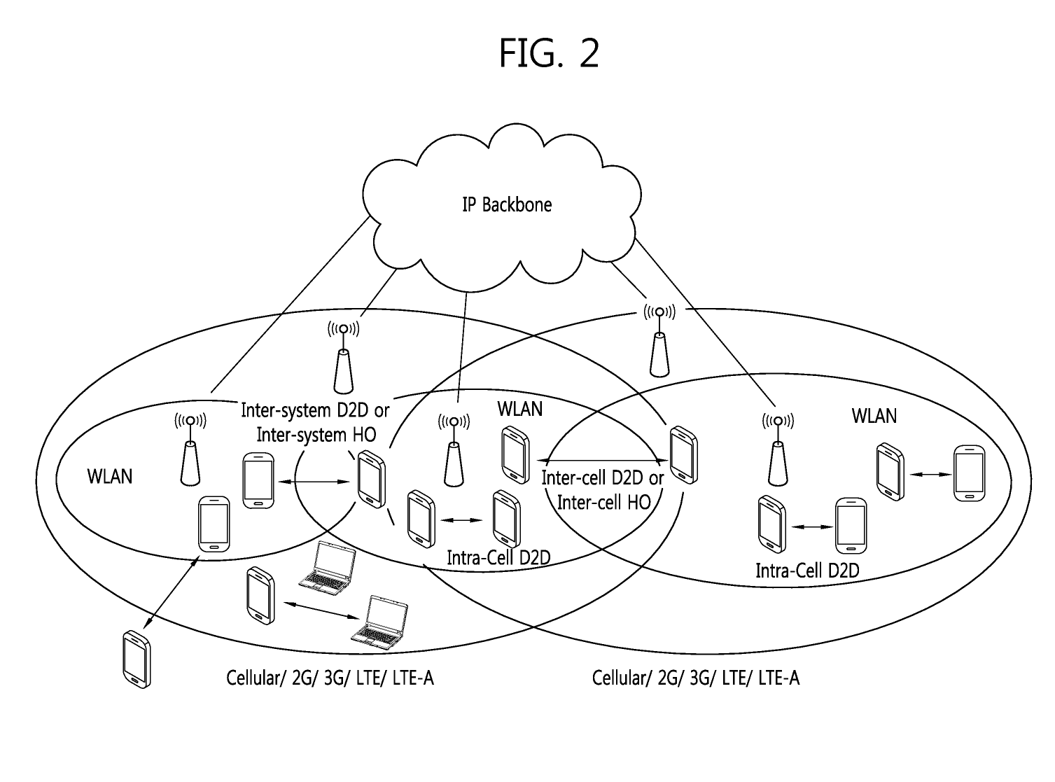

FIG. 2 shows an embodiment in which BS cells are operated in an overload control state according to the present invention.

Referring to FIG. 2, when an overload is generated in a network, the network can search for UE capable of D2D communication and provide D2D communication to the UE capable of D2D communication. In this case, the D2D communication may be provided to only traffic capable of D2D communication. When searching for UE capable of D2D communication, the network can search for the capabilities of the UE, a location of the UE, a location of a BS cell, and access information. If it is determined that an overload control mode needs to be entered, a network, that is, the subject of overload control, checks UE (and traffic) capable of D2D communication by searching a DB periodically or aperiodically and preferentially applies D2D communication to the retrieved UE (and traffic) capable of D2D communication. In this case, regarding traffic being served in the edge area of a BS cell, there are problems in that a service interruption problem that may occur because the intensity of a reception signal is low when handover is performed can be improved and the continuity of existing service can be guaranteed without imposing a load on a network.

Next, the network determines whether or not handover can be performed on UE (and traffic) not capable of D2D communication and performs handover according to a possible handover type. Here, when performing handover, the network can preferentially process real-time traffic that is greatly subject to a QoS influence. Furthermore, the network can determine whether or not a handover procedure having the smallest signaling necessary when performing handover can be first performed and then perform corresponding processing. For example, the network can perform control so that inter-cell handover and inter-system handover are sequentially performed by giving priority to the inter-cell handover and the inter-system handover. In this case, the continuity of service can be guaranteed because a load of the signaling and traffic of an overload network is reduced.

In accordance with the method, when an overload is generated in a network, D2D communication can be performed between UEs that are located in a cell edge area or a service area where UEs can directly communicate with each other in a cell. Accordingly, the continuity of existing served traffic can be guaranteed without imposing a load on a network. Next, handover is performed on UE (and traffic) not capable of D2D communication. Accordingly, when an overload is generated in a network, congestion of signaling and traffic that may occur when all the UEs connected to a corresponding cell perform handover at the same time can be prevented.

An apparatus for performing a method of controlling traffic (overload) according to the present invention can be called an overload control apparatus. The overload control apparatus can be included in part of a network. For example, the overload control apparatus can be included in an eNB or an EPC.

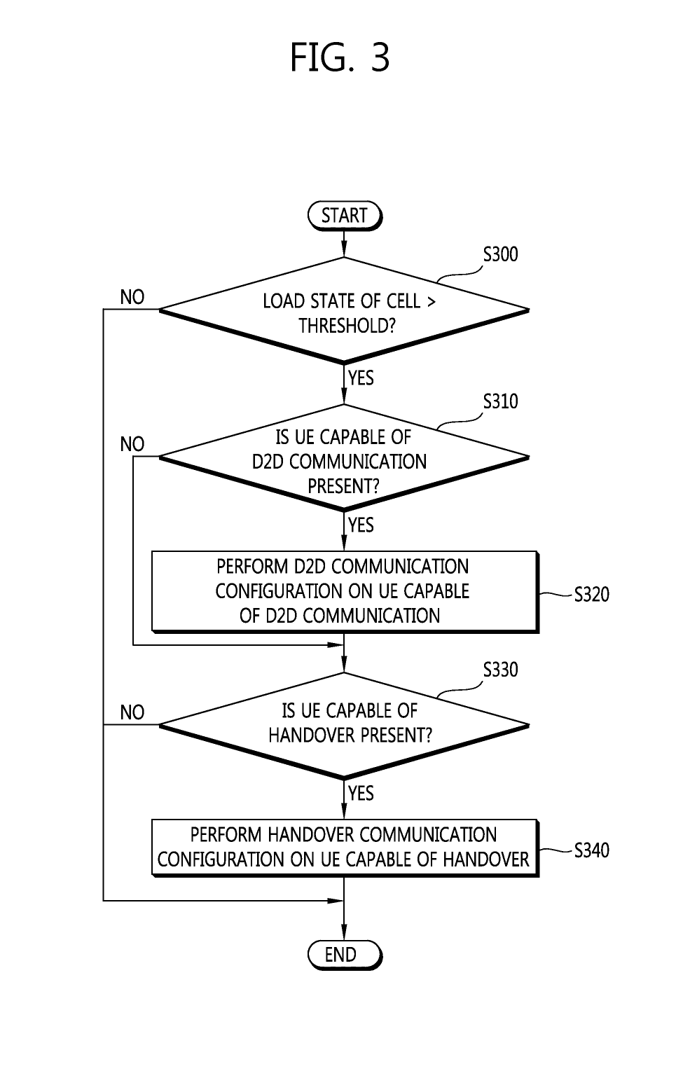

FIG. 3 is a flowchart illustrating an example of a method of controlling traffic (overload), which is performed by the overload control apparatus according to the present invention. FIG. 3 may illustrate a traffic (overload) control procedure in the operation of a BS cell in the traffic (overload) control state of FIG. 2.

Referring to FIG. 3, the overload control apparatus can monitor a network load state and a failure state.

The overload control apparatus determines whether a cell load state is greater than a threshold at step S300. The overload control apparatus can periodically or aperiodically search for and check a load that can be collected from a viewpoint of a network. Here, parameters for determining a load on a cell (or network) may be various. The parameters can include at least one of Quality Of Service (QoS), the number of UEs being served, the amount of wired and wireless resources being used for service, a Bit Error Rate (BET) of transmission and reception data, the intensity of transmission and reception signals, and the battery remains of UEs.

The threshold may be a predefined threshold or may be a threshold determined by the overload control apparatus based on a network state. For example, the overload control apparatus may determine the threshold based on any one of the parameters or may determine the threshold by generally taking some of the parameters into consideration. In determining the threshold, the overload control apparatus needs to place a margin in which at least overload control can be performed. If the margin is not placed, an overload control scheme proposed by the present invention may not be applied because the switch-off of a cell is generated due to a network failure and QoS may be deteriorated.

If, as a result of the determination at step S300, it is determined that the cell load state is greater than the threshold, the overload control apparatus determines whether or not UE capable of D2D communication is present UEs connected to the corresponding cell, at step S310. Here, the ‘UE capable of D2D communication’ can refer to UE which is equipped with D2D communication means and is using traffic to which D2D communication can be applied. For example, if the cell load state is greater than the threshold, the overload control apparatus can request information about UE capable of D2D communication, from among UEs connected to the corresponding cell (or network), and information about the state of a neighbor cell (or adjacent cell) from a specific DB within the network, such as an Operation, Administration, Maintenance (OAM) server, and receive the information about UE capable of D2D communication and the information about the state of a neighbor cell (or adjacent cell) from the DB. The overload control apparatus can determine UE capable of D2D communication based on the information about UE capable of D2D communication.

If, as a result of the determination at step S310, it is determined that UE capable of D2D communication is present, the overload control apparatus performs a D2D communication configuration on the UE capable of D2D communication at step S320. Here, the ‘D2D communication configuration’ can include requesting D2D call setup from the UE capable of D2D communication and receiving a D2D call setup completion message. In this case, the UE capable of D2D communication can maintain connection with the corresponding cell for the exchange of minimum signals with an eNB. For example, the UE capable of D2D communication can maintain a signal channel in order to send information, such as D2D communication traffic termination or a change of a communication environment in the corresponding cell, to the eNB. In general, in D2D communication, a load of signals influences an existing cell when a D2D communication configuration is performed because UEs directly perform communication with each other using a radio channel without using a network. However, when the D2D communication configuration is completed, a load on an overload network can be reduced because the UEs communicate with each other without via network nodes. Accordingly, if the number of UEs capable of D2D direct communication is increased, the amount of resources used by an overload network can be reduced, thereby reducing a possibility that a network may be switched off. Furthermore, an overload occurring in an existing cell (or serving cell) or a neighbor cell (or target cell) because a lot of UEs perform handover at the same time when a network is switched off can be prevented.

Next, the overload control apparatus determines whether or not UE capable of handover is present in the remaining UEs connected to the corresponding cell at step S330. The overload control apparatus can determine UE capable of handover in the remaining UEs not capable of D2D communication based on information about a neighbor cell (or adjacent cell) that has been obtained from the DB. Meanwhile, if, as a result of the determination at step S310, it is determined that UE capable of D2D communication is not present, the overload control apparatus can perform step S330.

If, as a result of the determination at step S330, it is determined that UE capable of handover is present, the overload control apparatus performs a handover communication configuration on the UE capable of handover at step S340. In this case, the overload control apparatus can preferentially perform handover on real-time traffic that is greatly subject to a QoS influence. Furthermore, the overload control apparatus can determine whether or not a handover procedure having the smallest signaling necessary when performing the handover can be preferentially performed and perform corresponding processing. For example, the network can perform control so that inter-cell handover and inter-system handover are sequentially performed by placing priority to the inter-cell handover and the inter-system handover. In this case, the continuity of service can be guaranteed because a load of the signaling and traffic of an overload cell is reduced.

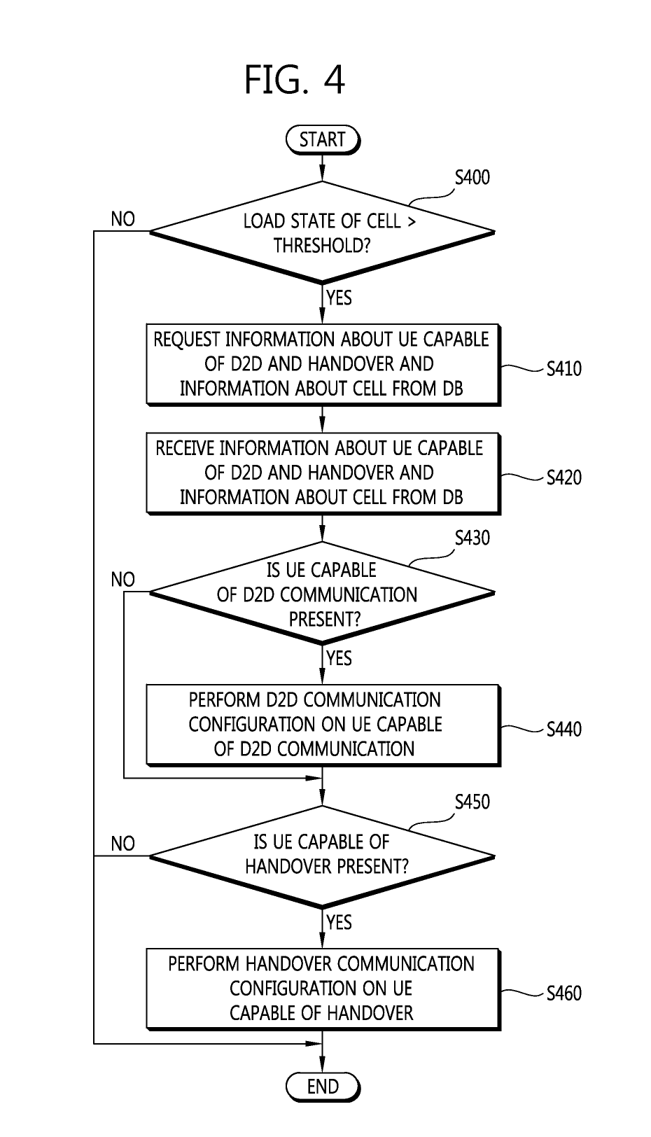

FIG. 4 is a flowchart illustrating another example of a method of controlling traffic (overload), which is performed by the overload control apparatus according to the present invention.

Referring to FIG. 4, the overload control apparatus can monitor a network load state and a failure state. The overload control apparatus determines whether or not a cell load state is greater than a threshold at step S400. The overload control apparatus can periodically or aperiodically search for and check a load that can be collected from a viewpoint of a network. The threshold may be a predefined threshold or may be a threshold determined by the overload control apparatus based on a network state.

If, as a result of the determination at step S400, it is determined that the cell load state is greater than the threshold, the overload control apparatus can request at least one of information about UE capable of D2D communication and information about UE capable of handover, from among UEs connected to a corresponding cell (or network), and information about the state of a neighbor cell (or adjacent cell) from a specific DB within the network, such as an OAM server at step S410. The overload control apparatus receives at least one of the information about UE capable of D2D communication, the information about UE capable of handover, and the information about the state of a neighbor cell (or adjacent cell) from the DB at step S420.

The overload control apparatus determines whether or not UE capable of D2D communication is present in the UEs connected to the corresponding cell at step S430. Here, the ‘UE capable of D2D communication’ can refer to UE which is equipped with D2D communication means and is using traffic to which D2D communication can be applied. The overload control apparatus can determine UE capable of D2D communication based on the information about UE capable of D2D communication.

If, as a result of the determination at step S430, it is determined that UE capable of D2D communication is present, the overload control apparatus performs a D2D communication configuration on the UE capable of D2D communication at step S440. Here, the ‘D2D communication configuration’ can include requesting D2D call setup from the UE capable of D2D communication and receiving a D2D call setup completion message. In this case, the UE capable of D2D communication can maintain connection with the corresponding cell for the exchange of minimum signals with an eNB. For example, the UE capable of D2D communication can maintain a signal channel in order to send information, such as D2D communication traffic termination or a change of a communication environment in the corresponding cell, to the eNB. If the D2D communication configuration is not completed, the overload control apparatus can perform the D2D communication configuration repeatedly.

The overload control apparatus determines whether or not UE capable of handover is present in the remaining UEs connected to the corresponding cell at step S450. The overload control apparatus can determine whether or not UE capable of handover is present in the remaining UEs not capable of D2D communication based on the information about UE capable of handover and the information about a neighbor cell (or adjacent cell) which have been obtained from the DB. Meanwhile, if, as a result of the determination at step S430, it is determined that UE capable of D2D communication is not present, the overload control apparatus can perform step S450.

If, as a result of the determination at step S450, it is determined that UE capable of handover is present, the overload control apparatus performs a handover communication configuration on the UE capable of handover at step S460. In this case, the overload control apparatus can preferentially perform handover on real-time traffic that is greatly subject to a QoS influence. Furthermore, the overload control apparatus can determine whether or not a handover procedure having the smallest signaling necessary when performing the handover can be first performed and perform corresponding processing. For example, the network can perform control so that inter-cell handover and inter-system handover are sequentially performed by placing priority to the inter-cell handover and the inter-system handover. The overload control apparatus can repeatedly perform the handover communication configuration if the handover communication configuration is not completed.

In accordance with the method of controlling traffic according to the present invention, in an overload network, D2D direct communication can be first applied, and handover to a neighboring cell (or target cell) can be then performed on traffic being served. Accordingly, the continuity of service can be guaranteed, and overload control efficiency of a system can be increased.

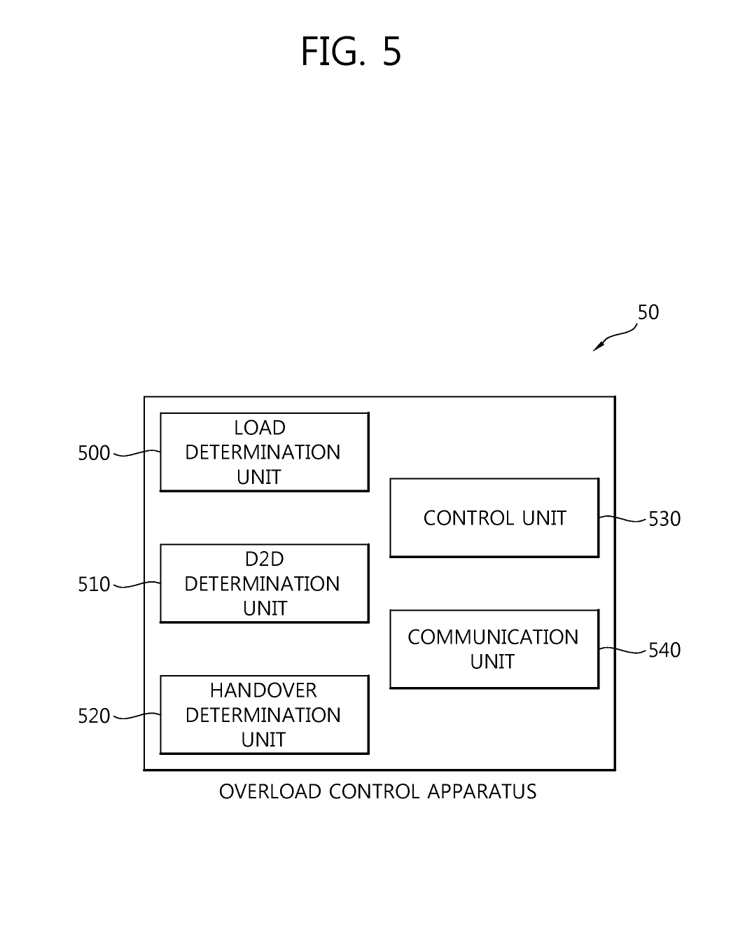

FIG. 5 is a block diagram of the overload control apparatus for performing traffic (overload) in a network according to the present invention.

Referring to FIG. 5, the overload control apparatus 50 according to the present invention includes a load determination unit 500, a D2D determination unit 510, a handover determination unit 520, and a control unit 530. The overload control apparatus 50 further includes a communication unit 540.

The load determination unit 500 determines whether or not the load state of a managed cell is greater than a threshold. The load determination unit 500 can determine the load state of the cell based on at least one of QoS, the number of UEs being served, the amount of wired and wireless resources being used for service, a BET of transmission and reception data, the intensity of transmission and reception signals, and the battery remains of UEs. Furthermore, the load determination unit 500 can determine the threshold based on at least one of QoS, the number of UEs being served, the amount of wired and wireless resources being used for service, a BET of transmission and reception data, the intensity of transmission and reception signals, and the battery remains of UE.

The communication unit 540 can request at least one of information about UE capable of D2D communication, information about UE capable of handover, and information about the state of a neighbor cell from a specific DB, such as the OAM server of a network, and receive at least one of the information about UE capable of D2D communication, the information about UE capable of handover, and the information about the state of a neighbor cell from the DB.

If, as a result of the determination, it is determined that the load state is greater than the threshold, the D2D determination unit 510 determines whether or not UE capable of D2D communication is present in UEs connected to the cell. The D2D determination unit 510 can determine whether or not UE capable of D2D communication is present based on the information about UE capable of D2D communication that has been received from the communication unit 540. The control unit 530 performs a D2D communication configuration on the UE capable of D2D communication.

The handover determination unit 520 determines whether or not UE capable of handover is present in the remaining UEs not capable of D2D communication. The handover determination unit 520 can determine UE capable of handover based on at least one of the information about UE capable of handover and the information about the state of a neighbor cell which have been received from the communication unit 540. The control unit 530 performs a handover communication configuration on the UE capable of handover.

In accordance with the present invention, in order to perform efficient traffic control when an overload occurs in a network, D2D communication in which UEs can perform direction communication is first performed before performing handover on UE that is being served in an existing cell, and direction communication between UEs is performed. Accordingly, a signaling overload due to the simultaneous handover of a plurality of UEs or congestion of traffic in a target cell can be prevented.

In accordance with the present invention, resource usage efficiency of a system can be maximized, and the continuity of service can be guaranteed. Furthermore, system performance can be improved by efficiently controlling a load on an eNB or an Evolved-Packet Core (EPC). In particular, QoS of a system can be guaranteed and system performance efficiency can be maximized by controlling a load on a network in addition to a load on a BS cell.

While some exemplary embodiments of the present invention have been described with reference to the accompanying drawings, those skilled in the art may change and modify the present invention in various ways without departing from the essential characteristic of the present invention. Accordingly, the disclosed embodiments should not be construed as limiting the technical spirit of the present invention, but should be construed as illustrating the technical spirit of the present invention. The scope of the technical spirit of the present invention is not restricted by the embodiments, and the scope of the present invention should be interpreted based on the following appended claims. Accordingly, the present invention should be construed as covering all modifications or variations derived from the meaning and scope of the appended claims and their equivalents.

What is claimed is:

1. A method of controlling traffic in a network in a mobile communication system, the method comprising:
determining whether or not a load state of a cell is greater than a threshold;
determining whether or not User Equipment (UE) capable of Device-to-Device (D2D) communication is present in UEs connected to the cell if, as a result of the determination, it is determined that the load state is greater than the threshold;
performing a D2D communication configuration on the UE capable of D2D communication;
determining whether or not UE capable of handover is present in remaining UEs not capable of the D2D communication; and
performing a handover communication configuration on the UE capable of handover.

2. The method of claim 1, wherein the load state of the cell is determined based on at least one of Quality of Service (QoS), a number of UEs being served, an amount of wired and wireless resources being used for service, a Bit Error Rate (BET) of transmission and reception data, an intensity of transmission and reception signals, and battery remains of UEs.

3. The method of claim 1, wherein the threshold is a predefined value or a value determined based on at least one of QoS, a number of UEs being served, an amount of wired and wireless resources being used for service, a BET of transmission and reception data, an intensity of transmission and reception signals, and battery remains of UEs.

4. The method of claim 1, wherein the UE capable of D2D communication is equipped with D2D communication means and is using traffic to which D2D communication is applicable.

5. The method of claim 1, wherein performing the handover communication configuration on the UE capable of handover comprises preferentially performing the handover communication configuration on UE to which real-time traffic is served.

6. The method of claim 1, wherein performing the handover communication configuration on the UE capable of handover comprises preferentially performing the handover communication configuration on UE having small signaling necessary when performing the handover communication configuration.

7. The method of claim 6, wherein performing the handover communication configuration on the UE capable of handover comprises preferentially performing the handover communication configuration in order of inter-cell handover and inter-system handover by placing priority to the inter-cell handover and the inter-system handover.

8. A method of controlling traffic in a network in a mobile communication system, the method comprising:
determining whether or not a load state of a cell is greater than a threshold;
requesting at least one of information about UE capable of Device-to-Device (D2D) communication, information about UE capable of handover, and information about a state of a neighbor cell from a specific database (DB) if, as a result of the determination, it is determined that the load state is greater than the threshold;
receiving at least one of the information about UE capable of D2D communication, the information about UE capable of handover, and the information about the state of a neighbor cell from the DB;
determining whether or not UE capable of D2D communication is present in UEs connected to the cell based on the received information about UE capable of D2D communication;
performing a D2D communication configuration on the UE capable of D2D communication;
determining whether or not UE capable of handover is present in remaining UEs not capable of D2D communication based on at least one of the received information about UE capable of handover and the received information about a state of a neighbor cell; and
performing a handover communication configuration on the UE capable of handover.

9. The method of claim 8, wherein the load state of the cell is determined based on at least one of Quality of Service (QoS), a number of UEs being served, an amount of wired and wireless resources being used for service, a Bit Error Rate (BET) of transmission and reception data, an intensity of transmission and reception signals, and battery remains of UEs.

10. The method of claim 8, wherein the threshold is a predefined value or a value determined based on at least one of QoS, a number of UEs being served, an amount of wired and wireless resources being used for service, a BET of transmission and reception data, an intensity of transmission and reception signals, and battery remains of UEs.

11. The method of claim 8, wherein the UE capable of D2D communication is equipped with D2D communication means and is using traffic to which D2D communication is applicable.

12. The method of claim 8, wherein performing the handover communication configuration on the UE capable of handover comprises preferentially performing the handover communication configuration on UE to which real-time traffic is served.

13. The method of claim 8, wherein performing the handover communication configuration on the UE capable of handover comprises preferentially performing the handover communication configuration on UE having small signaling necessary when performing the handover communication configuration.

14. The method of claim 9, wherein performing the handover communication configuration on the UE capable of handover comprises preferentially performing the handover communication configuration in order of inter-cell handover and inter-system handover by placing priority to the inter-cell handover and the inter-system handover.

15. An overload control apparatus for performing traffic control in a mobile communication system, comprising:
a load determination unit for determining whether or not a load state of a cell is greater than a threshold;
a D2D determination unit for determining whether or not User Equipment (UE) capable of Device-to-Device (D2D) communication is present in UEs connected to the cell if, as a result of the determination, it is determined that the load state is greater than the threshold;
a control unit for performing a D2D communication configuration on the UE capable of D2D communication; and
a handover determination unit for determining whether or not UE capable of handover is present in remaining UEs not capable of the D2D communication,
wherein the control unit performs a handover communication configuration on the UE capable of handover.

16. The overload control apparatus of claim 15, wherein the load determination unit determines the load state of the cell based on at least one of Quality of Service (QoS), a number of UEs being served, an amount of wired and wireless resources being used for service, a BET of transmission and reception data, an intensity of transmission and reception signals, and battery remains of UEs.

17. The overload control apparatus of claim 15, wherein the load determination unit determines the threshold based on at least one of QoS, a number of UEs being served, an amount of wired and wireless resources being used for service, a BET of transmission and reception data, an intensity of transmission and reception signals, and battery remains of UEs.

18. The overload control apparatus of claim 15, further comprising a communication unit for requesting at least one of information about UE capable of D2D communication, information about UE capable of handover, and information about the state of a neighbor cell from a database (DB) of a network and receives at least one of the information about UE capable of D2D communication, the information about UE capable of handover, and the information about the state of a neighbor cell from the DB.

19. The overload control apparatus of claim 18, wherein the D2D determination unit determines whether or not the UE capable of D2D communication is present based on the information about UE capable of D2D communication.

20. The overload control apparatus of claim 18, wherein the handover determination unit determines whether or not the UE capable of handover is present based on at least one the information about UE capable of handover and the information about the state of a neighbor cell.
